(19) United States
(12) Patent Application Publication
(10) Pub. No.: US 2008/0010147 A1
(43) Pub. Date: Jan. 10, 2008

(54) System and method for calculating employee recognition benefits in the form of fuel credits

(75) Inventor: Shana Emerson, Fulton, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/483,715

(22) Filed: Jul. 10, 2006

(51) Int. Cl. G06Q 30/00

(52) U.S. Cl. 705/14

(57) ABSTRACT

The present invention relates to a method and system for calculating employee or member recognition benefits in the form of fuel credits. More particularly, the system and method described in the instant specification provides a mechanism for determining awards in the form of fuel products such as gasoline, propane, diesel, kerosene, heating oil and other similar consumer oriented consumables in order to assist employees or members in meeting the demands of increased costs and for providing additional incentive vehicles in order to meet operating unit, divisional and corporate objectives and targets. The system utilizes a number of parameters that relate specifically to the employee or member of the organization and computes an award figure based on corporate or unit operating conditions as well as availability of supplies of fuel type products from participating suppliers.

### CROSS-REFERENCES TO RELATED APPLICATIONS

None.

### FIELD OF THE INVENTION

The present invention relates to a method and system for calculating employee or member recognition benefits in the form of fuel credits. More particularly, the system and method described in the instant specification provides a mechanism for determining awards in the form of fuel products such as gasoline, propane, diesel, kerosene, heating oil and other similar consumer oriented consumables in order to assist employees or members in meeting the demands of increased costs and for providing additional incentive vehicles in order to meet operating unit, divisional and corporate objectives and targets. The system utilizes a number of parameters that relate specifically to the employee or member of the organization and computes an award figure based on corporate or unit operating conditions as well as availability of supplies of fuel type products from participating suppliers.

### BACKGROUND OF THE INVENTION

There are many employee benefit programs ranging from healthcare to stock options and grants. Additional incentives may include quarterly or annual operating bonuses, usually distributed in the form of monetary outlays as well as seasonal gifts and company outings or retreats and other similar sponsored activities in which family members or employee or member guests may participate.

Stock options and incentives are normally calculated based on the particular salary grade or position level that an employee currently holds. This may be further manipulated based on corporate performance in which during periods of successful activity such options or grants may be increased by a certain multiple in order to reward the employee pool for their efforts in light of the market conditions that resulted in the enhanced company performance.

Likewise, cash bonuses or payouts are also often calculated based on the unit and corporate performance as well as a particular rating that may be applied based on the employee or member efforts during the reporting period. Such payments are typically made in addition to normal salary or other compensation outlays that are provided by the employer.

Other more conventional benefits have included health care accounts in which an employee or member may receive a different contribution level from the employer based on employee level or performance. Related benefits include such items as increased life insurance caps and additional insurance options for a spouse and dependants.

Still other incentives or enhanced compensation plans may include the award of additional vacation days in which depending on a unit, division or corporation achieving or exceeding a predetermined targets that are established at the beginning of a reporting period, members of the unit may receive additional vacation hours, days or weeks depending on the success of the combined efforts of the members of a particular operating unit or division.

Many companies and organizations also offer service awards, such as the completion of five, ten, fifteen, etc. anniversaries with an organization. These awards may be issued in the form of gifts, such as jewelry, clothing, furnishings, trips, etc. or can also at the option of the employee and employer be made in the form of an additional cash payment equal to the value of the gift article that may have been ordinarily awarded. Other awards may be provided for an employee's birthday, birth of a child, wedding or other significant personal event.

Despite the various incentives and benefits that are available in the work place today employers still look for other mechanisms by which to reward good employees and to attract new skilled new hires to their organizations. Various factors in the market place have also caused employers to become more creative in their efforts to retain a stable workforce and to ensure that the needs of the employee population are being met so as to maintain stability within the operating units of the company.

What is needed therefore is a method and system by which an employer can address current market conditions that effect the employees or members of a particular organization in order to help alleviate trends which may be temporary or more sustained due to economic or political conditions.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, one area that has been regularly overlooked in connection with employee incentive or compensation plans has been the area related to consumable products or necessities. While cash awards can simply be used to obtain these products or services, often the recipient will use the monetary distribution to purchase other items, such as luxury items or to pay off existing bills.

The present invention is directed to a method and system by which an employer can issue additional or alternative incentive awards to employees in the form of fuel credits which may take the form of gasoline, diesel, propane, heating oil, kerosene and the like in order to help employees offset the increased costs of getting to work or in maintaining a comfortable home environment. The system and method of the present invention uses a number of criteria, including select data groups relating specifically to an employee or unit member and combines those with operating performance details and availability of supply of fuel credits from participating suppliers of such consumables.

In one exemplary embodiment of the present invention, a method for calculating employee recognition awards in the form of fuel credits is described and includes the steps of, initially creating a first data base the first data base contains a listing of all employees in an organization. The first data base further includes details relating to the years of service of each employee, their respective salary and grade levels and their performance ratings, such as may occur during quarterly or annual reviews.

A second data base is generated and includes a grouping of performance targets for each operating unit in the organization. A third data base is provided in connection with the presently described embodiment. The third data base includes a number of fuel suppliers and available fuel credits available from each of the suppliers as well as the quantities of fuel types provided by each of the suppliers.

Next, a pool of available fuel credits from the suppliers is calculated with the pool including the limits of the fuel types that are available for selection under the program. A group of employees is then selected from the first data base that meet certain established criteria based on performance related activities. The group of employees is matched with information contained in the second data base to determine if an employee works in an operating unit that has achieved certain performance criteria to obtain an award set. Once the award set has been determined, then the award set is compared to the available fuel credits to see if there is a sufficient quantity of fuel credits available. Then the fuel credits are issued to each member of said award set.

In a further embodiment of the presently described invention, a method for issuing fuel credits as part of an employee recognition program is described and includes the steps of initially creating a first data base, with the first data base containing information that pertains to each employee of a company. The first data base includes years of service, salary and grade level and performance ratings for each employee.

Next, employee preferences with respect to available fuel types are collected. The preferences may include a choice between home heating products, e.g. heating oil, kerosene or propane, or fuel for a vehicle such as gasoline or diesel fuel. The employee preferences are then input into the first data base for use at a time of award determination.

A second data base is provided and includes suppliers of the available fuel types and quantities of credits available for each of the fuel types from each of the suppliers. Then a determination is made concerning which of the employees are eligible for a grant of an award of fuel credits. Once the determination is made, then the employee preferences are compared with the available fuel types to see if sufficient fuel is available for distribution. Then a proportionate share of the credits for each of the eligible employees is distributed based on performance criteria obtained from the first data base.

Once the award information has been determined, then a personalized award certificate is printed or imaged with the certificate including at least an employee name, amount of the credits issued to the employee and a personalized message, preferably from a member of management. Then the award certificate is distributed to the eligible employee such as through a printed card, gift card, greeting card or the like.

In a yet still further exemplary embodiment that may be practiced in accordance with the present invention, method for providing fuel credits as part of an employee incentive program is described and includes the steps of initially creating an employee data base, with the employee data base containing details on each employee of a company. The details contained in the data base include employee performance ratings and salary and grade level.

Performance targets are then determined for each employee and operating division of the company which are input into a second data base.

A third data base is provided with the third data base including a listing of possible fuel suppliers that are willing to participate in an employer sponsored program. The listing further includes available fuel types and quantities of the fuel types reserved for the program.

Employees are selected for participation in the program, with the selection based on for example performance criteria that are obtained from the first data base and the second data base. Each of the employees is then notified of their selection and eligibility for participation in the program. Each of the employees that have been selected is then permitted to choose fuel types and suppliers from the third data base.

Based on the employee selection a fuel card is printed that has a quantity of fuel credits and also preferably includes some personalized information pertaining to the employee and then the fuel card is distributed to the employee, such as through a gift card format, announcement or the like.

In practicing each of the foregoing embodiments, one or more additional steps may be utilized in order to complete certain aspects of the employee recognition program. For example, the program may be used to calculate income tax obligations due to the value of the award created for the employee. The program can also be used to “gross up” wages or payments to the taxing authorities in order to overcome any additional income tax burden that may be due by the employee.

In distributing the award to the employee, personalized messages may be created as part of the award grant and the certificate may be presented in a greeting or gift card type of format. In addition, reports may be printed for the purposes of monitoring the program and announcements can be created for the purposes of notifying others in the organization of the performance of one or more employees or groups of employees in a particular operating unit or organization.

It may be necessary to modify the award type based on market conditions and the system and method can recalculate the value based on increases or decreases in prices as opposed to when the fuel quantities or credits were obtained or combinations of fuel credits can be issued depending on either the availability of certain fuel quantities or alternatively based on the employee preference.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of a system that may be utilized in practicing the exemplary method embodiments of the presently described invention;

FIG. 2 shows a block diagram setting forth the steps that may be utilized in practicing the illustrated exemplary embodiment of the presently described invention;

FIG. 3 provides a further block diagram setting forth the steps that may be utilized in practicing the illustrated exemplary embodiment of the presently described invention; and

FIG. 4 presents a yet further block diagram setting forth the steps that may be utilized in practicing the illustrated exemplary embodiment of the presently described invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The present invention represents an innovative mechanism to either supplement or expand a compensation or benefit package for an employee or member or groups of individuals that are part of a larger organization such as an operating unit or division that may be part of a yet still larger entity such as a corporation. The exemplary methods used in practicing the present invention provide a means for distributing fuel credits as a reward for performance and achieving certain targets.

There are a number of terms used throughout the instant specification which are discussed below in cursory terms. The definitions provided are not intended to limit the scope of the invention and the information is provided for illustrative purposes.

As used herein, the term “business communication piece or document” refers to a substrate that, either alone or in combination with other documents, can convey a particular message or image or provide information about a particular product or service that is available from the provider of such pieces or documents. Business communication documents or pieces that are used in connection with the present invention can include cards, certificates, gift and greeting card platforms any one of which may also include advertising, sales and marketing collateral and such other items used to convey information.

The term “personalized information” refers to information that is printed or imaged onto a substrate, which is generally variable or unique and which may change from document to document or segment to segment so as to create a customized message or communication for each recipient. Examples of personalized information may include names, addresses, descriptions, plans, award amounts, monetary equivalents, coding, numbering, promotional text, etc. that may have been acquired from the intended recipient through answers given to various inquiries generated in response to a request for data or information.

The term “static or fixed” information refers to printed or imaged information that generally does not change from document to document or segment to segment and may include a general description or body of information about particular products, services, places, etc. that may be of interest or use to the recipient and represents a standard message that the manufacturing or supplier wishes to convey to an end user or customer of the offering.

The term “fuel” as used herein refers to consumable combustible products such as gasoline, diesel, kerosene, propane, heating oil and combinations thereof. Fuel may be consumed in a vehicle such as an automobile or may be utilized in heating a building such as a residence or other acceptable uses for the fuel.

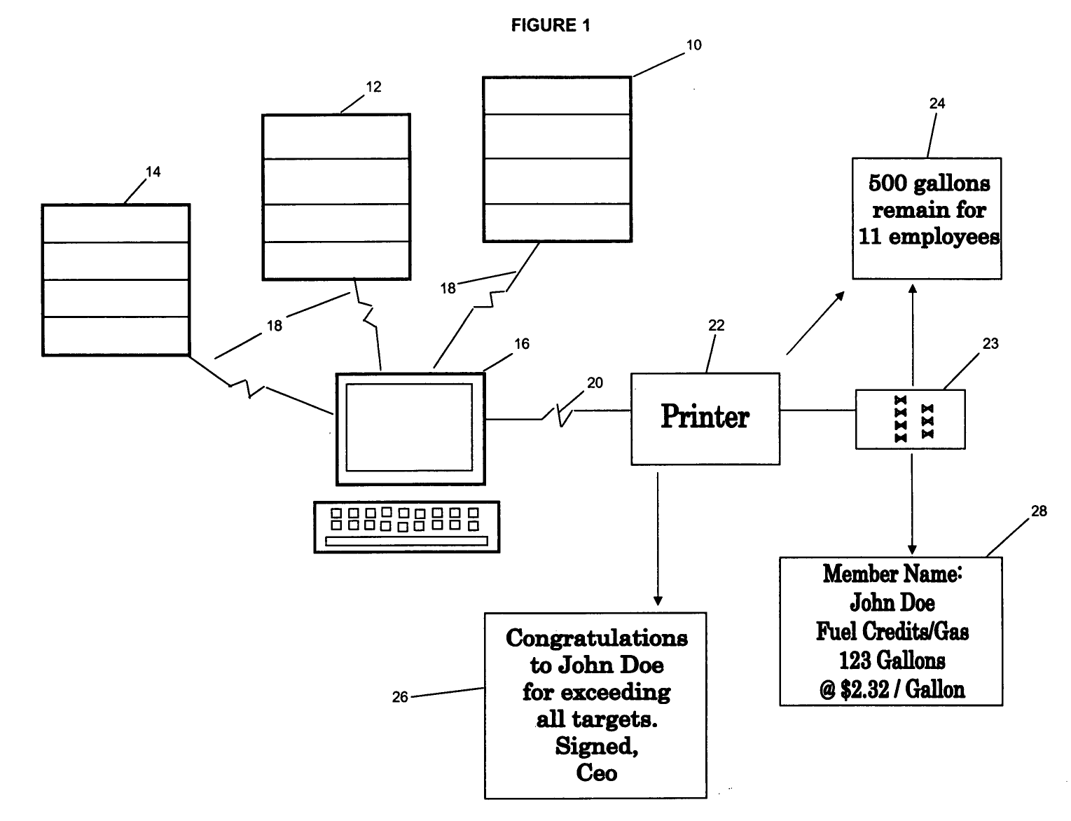

Reference is now directed to FIG. 1 which provides a schematic of an exemplary system that may be used in carrying out one or more preferred methods that are described herein. The system includes a first data base 10 which is intended to contain information relating to employees or members of an organization. The data base 10 may be populated with various details relating to each employee or member such as the number of years of service that an employee has been engaged in the provision of services to the company, salary and grade level or title, as well as performance rankings such as those that may have been obtained such as from a performance review or other human resources based activity.

The system includes a second data base 12 which may include unit or divisional performance targets as well as corporate targets. Targets for various business units are typically established at the beginning of a fiscal year and often include economically defined performance levels, project or milestone attainment expectations and such other details that a company or organization may assign to a particular division or operating unit.

A third data base 14 is also provided and will generally include information relating to fuel suppliers that are willing to participate in providing product for the employee recognition program. The information contained in the third data set will also include the type of fuel that is available from each supplier, e.g. gasoline, kerosene, propane, diesel fuel, heating oil or combinations thereof. In addition, the third data base will include a quantity of each fuel type that is either available from each supplier or which a company has purchased from each supplier or has allocated for the program and is available for distribution to eligible employees.

Each of the data bases 10, 12 and 14 are connected to a computer 16 that is used for inputting information into the data bases as well as for extracting information and for running comparative data. For example, employees or members of operating units may be asked to express a preference for a particular fuel type which may be determined by the type of the vehicle an employee operates or the needs of an individual during different seasonal situations. For instance, in the summer an employee may select to receive gasoline or diesel fuel to operate a car or truck, but if the award is made during the winter season, then the employee may select propane, kerosene or heating oil in order to heat the residence where the employee resides.

The computer 16 is connected to the first, second and third data bases 10, 12 and 14 though for example a LAN (local area network), WAN (wide area network) or the connection may also be provided through a global communications network where the divisions may be located at different geographic locations. The connections are represented by numeral 18.

In addition, the computer 16 can be used to update information relating to usage or consumption of fuel quantities awarded and the availability of the types of fuel that remains available for distribution within the program.

The computer 16 will also be used to run calculations to determine eligibility for each employee that is contained in the first data base 12. For example, assume that an employee has ten years of service and holds a salary and grade level of three. In addition, the employee has been rated as meeting his or her objectives and is given a ranking of three on a scale of five. The computer 16 will issue an initial employee rating of sixteen (3+3+10=16). The computer 16 then checks to see if the business unit or operating division to which the employee belongs has met its targets. Assuming that the business unit is on track, the unit is given a ranking of three, again on a scale of five and the business unit ranking is then used as a multiplier with the employee ranking of sixteen or a total of forty eight units. The units that are eligible for award may then be applied in a direct one to one relation to the fuel available, for example forty eight gallons of gasoline may be issued. Alternatively, market conditions may be taken into consideration and if the price of gasoline is twice as much as when the fuel was initially reserved for the program, then only twenty four gallons may be issued. Obviously, any sort of multiples may be used in determining the award to the employee or member of the organization and the formulas and the weight to apply to each element that is generated from a query of the system.

The computer 16 will also perform other calculations such as any income tax obligations that may be created for the employee due to the issuance of the award. If an additional tax obligation has been created, the employer may choose to “gross up” the award so as to cover any additional tax obligation so that the employee receives the full value of the award that the employer desires to issue.

The computer 16 is connected to a printer 22 through a similar connection 20 that connects the computer 16 to the first through third data bases represented by numeral 18. The printer 22 can be used for issuing various printed or imaged documents 23. The printer 22 can be used to generate management reports 24 which may show the quantity of fuel available in the program as well as the number of employees to which awards have been made. In addition, the management report may also include such other information as may be pertinent such as the names of the employees receiving the award, the amount distributed to each award, any taxation issues and the like.

The printer 22 may also be used to create announcements 26 for the benefit of the employee. The announcement may contain personalized information such as the name of the employee, date of the award, a personalized message from a member of management, details relating to the award, such as expiration information, locations of suppliers and the like.

The printer 22 is also used to generate a fuel card or certificate 28 which may also be personalized to include information relating to the amount of the award, the identity of the recipient and monetary value of the award.

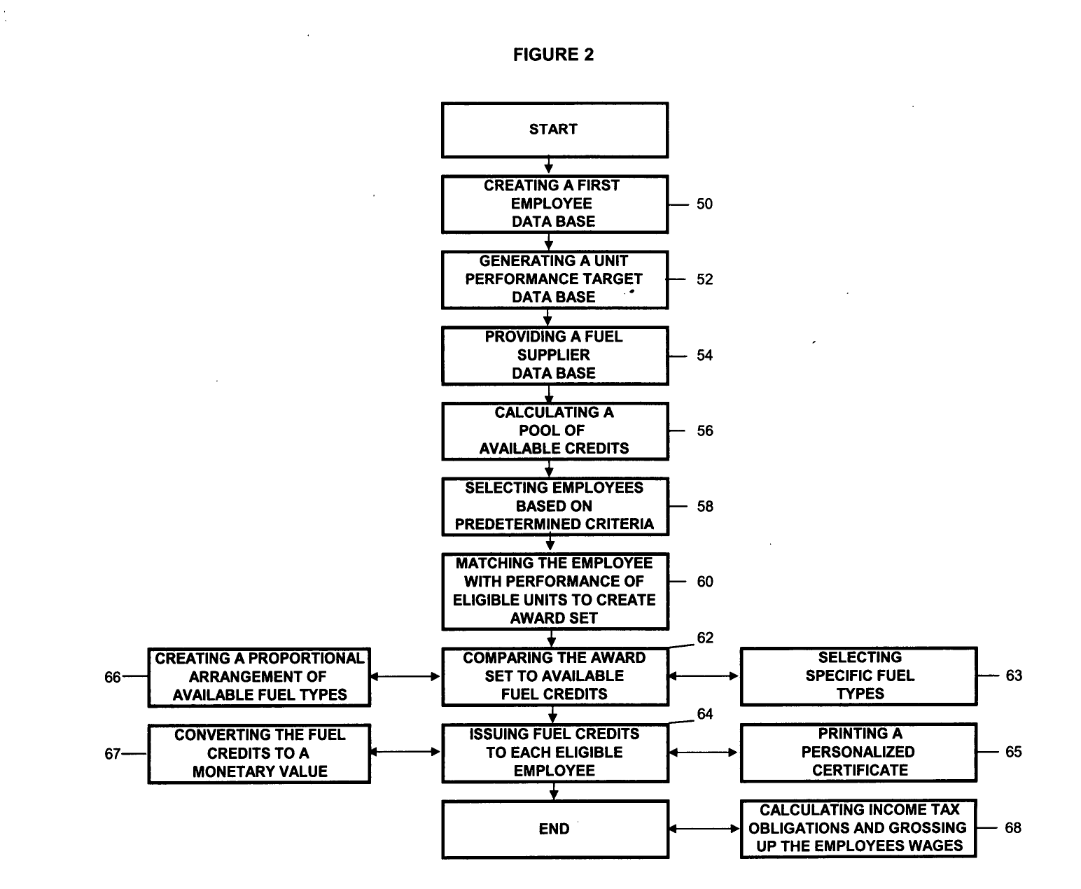

Attention is now directed to FIG. 2, which shows a block diagram setting forth an exemplary method of carrying out an award sequence in connection with the present invention. The process is begun by the creation of a first data base at step 50 which will include information relating to a group of employees that report in through a division or business unit or all employees within a corporation. The information that is entered into the data base includes generally details that would be available from a human resources department within an organization such as anniversary dates (time of service), salary, grade level, performance ratings and the like.

A second data base is created at step 52 which will include business unit, divisional and corporate performance targets, objectives and the like. The targets may be financial objectives, milestone or projects and relevant completion dates for each and such other criteria that may be added by the management of the organization in order to achieve certain objectives.

A supplier or third data base is created at step 54. The supplier data base will include details relating to the suppliers that are willing to participate in the program or which will accept the fuel cards or certificates that are issued by the company. In addition, the supplier data base may also hold information relating to the quantity and type of fuel products that are available for distribution to employees in the form of award certificates or gift cards.

At certain intervals during a calendar or fiscal year, such as quarterly, semi annually or annually, or other times to be determined by management of the company, a pool of available fuel credits is determined at step 56. Eligible employees for participation in the program and issuance of awards are determined at step 58. Eligibility for issuance of an award will be preferably determined by performance criteria, both at the personal or employee level and at the business unit or operational level.

Next, at step 60 the eligible employees are matched with the performance of the business units in order to create an award set which includes the number of employees and the business units in which the report through. At step 62, the award set is then compared with the available fuel credits that exist in the program to determine allocation of the credits to specific employees. For example, an employee with more years of service but receiving the same performance ranking and have the same salary grade or level as a second employee would receive a larger fuel credit award due to a greater multiplier of the service tenure. Various permutations on the formula and the calculation used to determine the awards to the employees are of course subject to management discretion and implementation.

Employees may also be given the opportunity to select the types of fuel credits they may wish to receive at step 63. Employees may of course also have the option of donating the fuel credits to a charity or others that may be in need of assistance.

Next, fuel credits are issued as cards or certificates at step 64 to each of the eligible employees. The certificates or cards are printed at step 65 and the printing may include the imaging of personalized information as well as static or fixed printing such as the name of all of the suppliers and their location.

Where necessary, a proportional allocation or arrangement of the available fuel credits may be made at step 66. This can be used to shift allocations to different employees based on an employee receiving a higher score, or alternatively having a certain intangible that is recognized by management and put into the system. The fuel credits may also be assigned a monetary value at step 67 such that an employee can redeem the award at a supplier that may not have signed up to participate in the program. Alternatively, if the employee chooses, the employee can redeem the value through the organization and receive a cash distribution.

If necessary, the method can calculate the tax implication that may be created for the employee at step 68. If management elects, the calculation can also include the “grossing up” of the amount so that the taxes due on the award are paid by the employer and the employee receives the full benefit of the award.

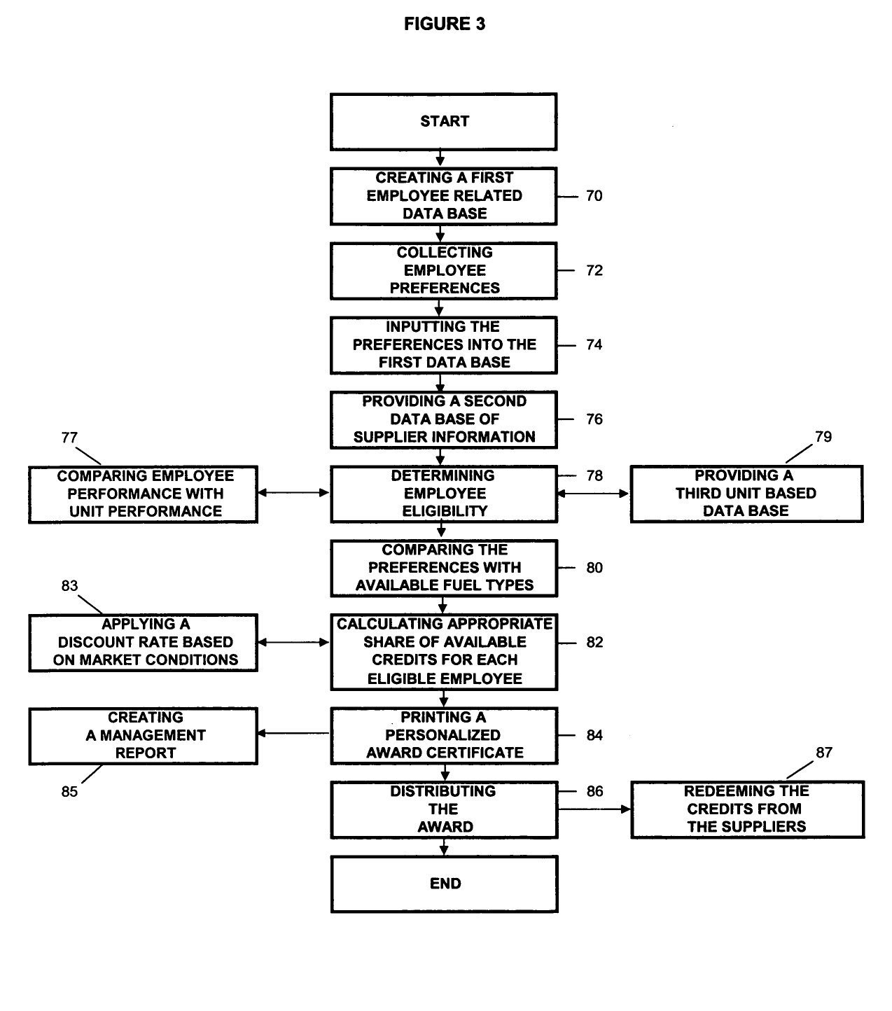

Turning now to FIG. 3, which provides a block diagram setting forth the steps that may be utilized in carrying out a further exemplary embodiment of the present invention. The process is again begun by creating a first employee data base at step 70. As indicated previously, the employee data base will be populated with information relating to the members of an organization. Employee preferences are collected at step 72, such preferences include fuel type selections as well as timing, such as seasonal, in which those selections will be applied. Those preferences are then input into the first data base at step 74.

Next, a second data base is populated at step 76 with information relating to suppliers that are participating in the program and the fuel types that are available from each supplier as well as the quantity of fuel each supplier may be able to provide to award recipients. Employee eligibility is determined at step 78. Eligibility may be decided on performance, or alternatively if management elects, the eligibility of employees may be need based.

Assuming that the eligibility is performance based then at step 77 the employee performance is compared with unit performance to determine if the employee reports into a division that has met its objectives, thereby making all employees in that unit eligible for participation in the award program. The unit performance is obtained from a third data base which is prepared at step 79.

Next, the employee expressed preferences are compared with the available fuel credits in the second data base at step 80. Then, a calculation is performed to determine the proportionate share of fuel to be allocated to each award recipient at step 82. Where necessary, a discount factor may be used at step 83 to adjust the fuel quantity up or down depending on current market conditions.

An award certificate, gift card or other suitable printed piece is provided at step 84 for each award recipient. A management report may also be created at step 85 which includes information on the number of employees receiving awards, the names of the employees, the quantities of fuel credits distributed and available credits remaining in the pool for distribution and such other information as management may require from the system.

The award certificates are then distributed at step 86 and the recipients of the awards are then able to redeem the awards at step 87 at either participating suppliers or alternatively, receive a cash or monetary value for the award in the event the employee elects not receive the distributed fuel credit. The process is then stopped and can be started again during the next cycle when awards are issued in accordance with corporate guidelines.

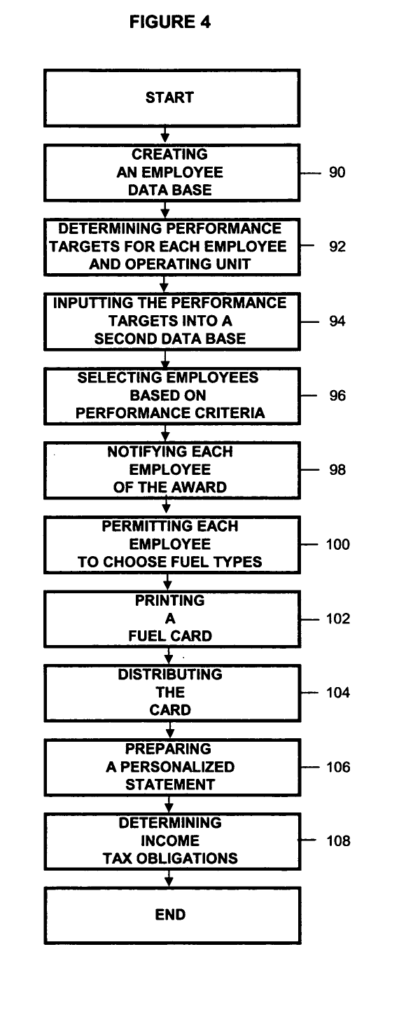

FIG. 4 provides a still further exemplary embodiment for practicing a method in accordance with the present invention. As before, the process is begun by creating an employee data base at step 90. Performance targets for each employee and business unit are determined at step 92 and then the performance targets are input into a second data base at step 94. Inputting of the data can be accomplished through use of a computer that is connected to each of the data bases that are used in connection with the invention.

Next, one or more employees or unit members are selected based on personal and unit performance at step 96, and then the employees that are determined to be eligible for an award are notified at step 98. Each employee that is selected for participation in the program is provided with an opportunity to make a choose of fuel types that are available from suppliers at step 100. A fuel card or certificate is then printed at step 102 and the cards are distributed at step 104. Next, a personalized statement is created at step 104. The statement may include a personalized message from management, as well as information pertinent to the award. Finally, tax obligations are determined at step 108 and management may make an election to remediate the obligations so that the employee receives the full benefit of the award.

It will thus be seen according to the present invention a highly advantageous method and system for providing employee recognition awards in the form of fuel credits has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method for calculating employee recognition awards in the form of fuel credits, comprising the steps of;
creating a first data base, said first data base containing a listing of all employees in an organization, said first data base further including details relating to years of services, salary and grade levels and performance ratings;
generating a second data base, said second data base including a grouping of performance targets for each operating unit in said organization;
providing a third data base, said third data base including a number of fuel suppliers and available fuel credits available from each of said suppliers and quantities of fuel types provided by each of said suppliers;
calculating a pool of available fuel credits from said suppliers, said pool including limits of said fuel types;
selecting a group of employees from said first data base meeting certain established criteria based on performance related activities;
matching said group of employees with said second data base to determine if an employee works in an operating unit achieving certain performance criteria to obtain an award set;
comparing said award set to said available fuel credits; and
issuing fuel credits to each member of said award set.

2. A method for calculating employee recognition awards in the form of fuel credits as recited in claim 1, wherein said fuel types are selected from a group consisting of gasoline, kerosene, diesel, heating oil, propane and combinations thereof.

3. A method for calculating employee recognition awards in the form of fuel credits as recited in claim 1, wherein said step of issuing fuel credits includes a further step of printing a personalized award certificate.

4. A method for calculating employee recognition awards in the form of fuel credits as recited in claim 3, wherein said personalized award certificate is presented in a personalized gift card.

5. A method for calculating employee recognition awards in the form of fuel credits as recited in claim 1, including a further step of determining a proportional arrangement of said fuel types for said award set based on performance criteria from said first data base after the step of comparing said award set to said available fuel credits.

6. A method for calculating employee recognition awards in the form of fuel credits as recited in claim 1, including a further step of selecting specific fuel types by each member of said award set prior to the step of issuing fuel credits to each member of said award set.

7. A method for calculating employee recognition awards in the form of fuel credits as recited in claim 1, including a further step of converting said fuel credits to a monetary value for redemption at a selected one of said fuel suppliers after the step of issuing fuel credits to each member of said award set.

8. A method for calculating employee recognition awards in the form of fuel credits as recited in claim 1, including a further step of calculating income tax obligations for each member of said award set after the step of issuing fuel credits to each member of said award set.

9. A method for calculating employee recognition awards in the form of fuel credits as recited in claim 8, including a further step of grossing up a value equal to said fuel credits for income tax purposes after the step of calculating income tax obligations for each member of said award set.

10. A method for issuing fuel credits as part of an employee recognition program, comprising the steps of;
creating a first data base, said first data base containing information pertaining to each employee of a company, said first data base including years of service, salary and grade level and performance;
collecting employee preferences with respect to available fuel types;
inputting said employee preferences into said first data base;
providing a second data base, said second data base including suppliers of said available fuel types and quantities of credits available for each of said fuel types from each of said suppliers;
determining which of said employees are eligible for a grant of an award of fuel credits;
comparing said employee preferences with said available fuel types;
calculating a proportionate share of said credits for each of said eligible employees based on performance criteria;
printing a personalized award certificate, said certificate including at least an employee name, amount of said credits issued to said employee and a personalized message; and
distributing said award certificate to said eligible employee.

11. A method for issuing fuel credits as part of an employee recognition program as recited in claim 10, including a further step of redeeming said credits at, at least one of said suppliers after the step of distributing said award certificate.

12. A method for issuing fuel credits as part of an employee recognition program as recited in claim 10, wherein said available fuel types are selected from a group consisting of gasoline, kerosene, diesel, heating oil, propane and combinations thereof.

13. A method for issuing fuel credits as part of an employee recognition program as recited in claim 10, including a further step of creating a third data base, said third data base including performance targets for each operating unit of said company and for said company after the step of providing a second data base.

14. A method for issuing fuel credits as part of an employee recognition program as recited in claim 13, including a further step of comparing said employee performance with said third data base to determine if said operating unit achieved said performance targets after the step of determining which of said employees are eligible for a grant of an award of fuel credits.

15. A method for issuing fuel credits as part of an employee recognition program as recited in claim 10, including a further step of applying a discount rate to one of said credits or award for said available fuel types due to market conditions after of comparing said employee preferences with said available fuel types.

16. A method for issuing fuel credits as part of an employee recognition program as recited in claim 10, including a further step of creating a management report to determine levels of participation and credit usage after the step of distributing said award certificate to said eligible employee.

17. A method for issuing fuel credits as part of an employee recognition program as recited in claim 10, including a further step of printing an announcement after the step of distributing said award certificate to said eligible employee.

18. A method for providing fuel credits as part of an employee incentive program, comprising the steps of;
creating an employee data base, said employee data base containing details on each employee of a company, said details including employee performance ratings and salary and grade level;
determining performance targets for each employee and operating division of said company;
inputting said performance targets for each employee and operating division in a second data base;
providing a third data base, said third data base including a listing of possible fuel suppliers willing to participate in an employer sponsored program, said listing further including available fuel type and quantities of said fuel types reserved for said program;
selecting employees for participation in said program due to performance criteria obtained from said first data base and said second data base;
notifying each of said employees of selection;
permitting each of said employees to choose fuel types and suppliers from said third data base;
printing a fuel card having a quantity of fuel credits; and
distributing said fuel card to said employee.

19. A method for providing fuel credits as part of an employee incentive program as recited in claim 18, including a further step of preparing a personalized statement for each of said employees receiving said fuel card, said personalized statement including at least a name and personalized congratulatory message from a member of management after the step of printing a fuel card having a quantity of fuel credits.

20. A method for providing fuel credits as part of an employee incentive program as recited in claim 18, including a further step of determining tax implications for each of said employees based on an award of fuel credits after the step of distributing said fuel card to said employee.
